(19) United States
(12) Patent Application Publication
(10) Pub. No.: US 2006/0290955 A1
(43) Pub. Date: Dec. 28, 2006

(54) Image forming apparatus

(75) Inventor: Yuusuke Suzuki, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/168,117

(22) Filed: Jun. 27, 2005

(51) Int. Cl. G06F 3/12; G06F 15/00

(52) U.S. Cl. 358/1.9; 358/3.23; 358/1.13

(57) ABSTRACT

An image forming apparatus for printing print data described in a page description language in a specific format has a multi-dimensional Lut color conversion processing unit configured to carry out color conversion processing of a device color space by using a multi-dimensional lookup table.

### BACKGROUND OF THE INVENTION

1. Field of the Invention

The present invention relates to an image forming apparatus which receives data in which contents to be printed have been described in a page description language (PDL), and carries out printing on the basis of the received data.

2. Description of the Related Art

Image forming apparatuses which receive data in which contents to be printed have been described in PDL and carries out printing exist. One PDL for use in printing is PostScript. PostScript has a plurality of methods of designating colors of an object to be drawn. Further, in PostScript, colors can be designated by color values of a color space dependent on a device, or color values of a color space independent of a device.

With respect to printing of data described in the PostScript language specification, when colors are designated in a DeviceRGB space which is a color space dependent on a device, and the printing is carried out in the process colors of cyan (C), magenta (M), yellow (Y), and black (B), the data is printed by color values calculated by a polynomial expression defined in the PostScript language specification.

Further, as in Jpn. Pat. Appln. KOKAI Publication No. 10-313412, there is a method by which color conversion is carried out by converting device colors into colors of a print color space with reference to a three-dimensional color conversion lookup table.

When printing based on the device RGB colors is carried out in a printer which can print print data in PostScript format, the data being CMYK-printable, there are two types of color conversion methods. One is color conversion by a polynomial expression. The other is color conversion in which RGB values are converted into color values of an XYZ color space on the basis of the setting of UseCIEcolor device parameters, and a multi-dimensional lookup table is referred to on the basis of the values. Specifically, as shown in FIG. 11, color conversion is carried out with reference to a multi-dimensional table (multi-dimensional color conversion table) when processing of a CIE-based color rendering dictionary is carried out after the device color space is converted into XYZ values.

When a user wishes for color conversion of device RGB colors by using a multi-dimensional table in order to adjust color tone, printing can be carried out by the latter color conversion method described above. However, as shown in FIG. 11, the color conversion is carried out with reference to the multi-dimensional table once after the device color space is converted into the color values of the XYZ color space, and therefore, the printing speed is made slow.

Accordingly, there is a need for an image forming apparatus in which colors of an object described in device colors can be customized more flexibly, and printing can be achieved in optimum colors.

### BRIEF SUMMARY OF THE INVENTION

In accordance with an aspect of the present invention, an image forming apparatus for printing print data described in a page description language in a specific format comprises a multi-dimensional Lut color conversion processing unit configured to carry out color conversion processing of a device color space by using a multi-dimensional lookup table.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a diagram schematically showing an internal configuration of a printer and a network configuration in a first embodiment of the present invention;

FIG. 2 is a flowchart for explaining image forming processing in the first embodiment;

FIG. 3 is a diagram for explaining color conversion processing of a device color space of received print data in the first embodiment;

FIG. 4 is a flowchart for explaining image formation processing in a second embodiment of the present invention;

FIG. 5 is a flowchart for explaining image formation processing in a third embodiment of the present invention;

FIG. 6 is a sub-flowchart of processing A in FIG. 5;

FIG. 7 is a flowchart showing processing executed at the time of receiving data in an ICC profile format in a fourth embodiment of the present invention;

FIG. 8 is a flowchart for explaining image formation processing in a fifth embodiment of the present invention;

FIG. 9 is a flowchart for explaining image formation processing in a sixth embodiment of the present invention;

FIG. 10 is a sub-flowchart of processing B in FIG. 9; and

FIG. 11 is a diagram for explaining color conversion processing of a device color space of received PDL data in the prior art.

### DETAILED DESCRIPTION OF THE INVENTION

Hereinafter, respective embodiments of the present invention will be described with reference to the drawings.

### First Embodiment

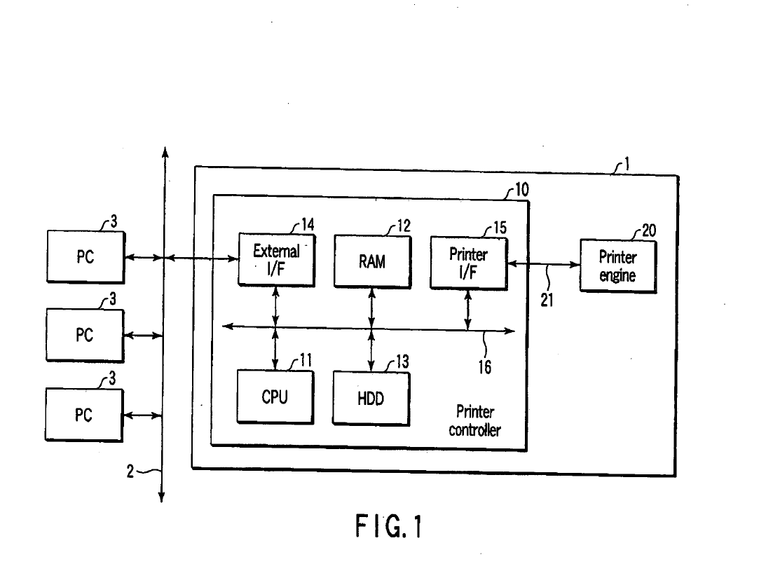

FIG. 1 is a diagram schematically showing an internal configuration of a printer 1 which is an image forming apparatus connected to a network 2 and a configuration of the network 2. As shown in FIG. 1, the printer 1 has a printer controller 10 and a printer engine 20. Further, the printer 1 is connected to a plurality of personal computers (PCs) 3 via the network 2.

In such a configuration, a user instructs the PC 3 to carry out printing. Then, print information is transmitted to the printer controller 10. The printer controller 10 converts the print information received from the PC 3 into image data for printing. Then, the printer controller 10 transmits the converted image data for printing to the printer engine 20. The printer engine 20 forms an image on a printing medium on the basis of the received image data for printing. Communication between the PC 3 and the printer controller 10 is carried out via the network 2. Further, communication between the printer controller 10 and the printer engine 20 is carried out via a communication path 21 through which high-speed data communication is possible.

Page description language (PDL) data, fonts, a PDL macroinstruction, color conversion table data, and the like which are supplied from the PC 3 are input to the printer controller 10. In the printer controller 10, an image for printing corresponding to contents to be inputted is formed in accordance with contents of description in PJL and PDL attached for control. Further, the printer controller 10 stores therein fonts, a PDL macroinstruction, table data for color conversion, and the like.

In the PC 3, an operating system (OS) is operated. On the OS, an application program and a printer driver are operated. As described above, the PC 3 is connected to the network 2 to which the printer 1 has been connected. Then, the PC 3 can make communication with the printer controller 10 of the printer 1. When a printing instruction is issued by a user, the PC 3 describes the contents of printing in PDL. The OS transmits the PDL data to the printer controller 10 via the network 2. With respect to a transmission of the PDL data, a print data communication protocol is used. The PDL data is transmitted by transmission control according to the aforementioned protocol. There are cases in which a user directly describes PDL data, or an application program prepares PDL data without passing through a printer driver. In such a case, in the same way as in a case of using a printer driver, the PDL data is transmitted to the printer controller 10 in accordance with the transmission procedure according to the print data transmission protocol by means of an application program for PDL data transmission, and a function provided by the OS. The plurality of PCs 3 shown in FIG. 1 can respectively transmit PDL data to the printer controller 10 in accordance with the same mechanism.

The network 2 is configured of network equipment such as a cable, a router, a gateway, a hub and a wireless router. In addition, the network 2 enables the devices connected thereto to communicate with each other. The PCs 3 and the printer 1 are connected to the network 2 via a cable, or a device for wireless LAN connection, and can communicate with each other.

The printer controller 10 receives the PDL data transmitted from the PC 3, and converts the received PDL data into an image for printing. Then, the printer controller 10 transmits the converted image data for printing to the printer engine 20. This processing relating to the formation of the image for printing is realized by a program operated at the inside. The printer controller 10 has an external interface (I/F) 14 which enables communication with the PCs 3, and a printer interface (I/F) 15 which enables communication with the printer engine 20 at the inside thereof. The program operated at the inside of the printer controller 10 carries out communication by using the respective I/Fs 14 and 15 via device drivers for controlling the I/Fs 14 and 15.

The printer controller 10 is configured of a CPU 11, a RAM 12, a hard disk drive (HDD) 13, the external I/F 14, the printer interface I/F 15, and a communication bus 16. The respective components are connected to the communication bus 16, and can make communication with the CPU 11. In addition, between the devices except for the RAM 12 and the CPU 11 as well, the respective components can make data communication by a direct memory access (DMA) communication system without passing through the CPU 11.

In the CPU 11, a program for carrying out processing relating to the printing is executed. The program relating to the printing (image formation) processing, PDL data, an image for printing, font data, and working data at the time of executing the program are stored in the RAM 12. A part of the region of the RAM 12 is made to be a nonvolatile RAM called an NVRAM. Data stored in the NVRAM is maintained even after turning off the power source of the printer 1. Therefore, setting information etc. relating to the printing and characteristic to the printer 1 are stored in the NVRAM. The received PDL data, resident fonts, and data into which a conversion table relating to color conversion, coefficients, and the like have been described are stored in the HDD 13. The PDL data is stored into the HDD 13 by only a program called a spooler, the program operating on the printer controller 10. In accordance therewith, an efficient use of the CPU 11 is realized. The communication bus 16 makes data communication between the CPU 11 and the other components in the printer controller 10, and the RAM 12 and the other components except for the CPU 11 in the printer controller 10. A program called a device driver for controlling the external I/F 14 and the printer I/F 15 resides on the RAM 12. When the program relating to the printing processing makes communication with the network 2, or communication with the printer engine 20, the communication is carried out via the device driver residing on the RAM 12. The device driver makes control of the external I/F 14 and the printer I/F 15, communication with a program which is the origin calling the device driver, and data transmission and reception between the respective I/Fs 14 and 15. Consequently, communication of the program operated in the printer controller 10 with the PCs 3 and the printer engine 20 is executed.

The printer engine 20 makes communication with the printer controller 10 via the communication path 21 of the printer controller 10. The printer engine 20 receives image data for printing from the printer controller 10, and prints in colors by using toners of cyan, magenta, yellow, and black to output the data on a printing medium such as a paper.

Hereinafter, the processings of programs operated on the printer controller 10 will be described. The programs are stored in the HDD 13. Then, the programs are loaded on the RAM 12 at the time of starting the printer controller 10, and are executed. The programs include a control program, a spooler program, and an image formation program. The control program is always operated, and carries out reception of print data and calling of another program, thereby realizing the processings in the printer controller 10. The control program calls the spooler program when PDL data is transmitted from the PC3 via the network 2. The spooler program spools the PDL data in the HDD 13. When the PDL data is stored in the HDD 13 by the spooler program, the control program calls the image formation program. The image formation program processes the spooled PDL data so as to be formed as an image. When an image for printing is formed, the control program transmits the image data for printing to the printer engine 20 via the printer I/F 15.

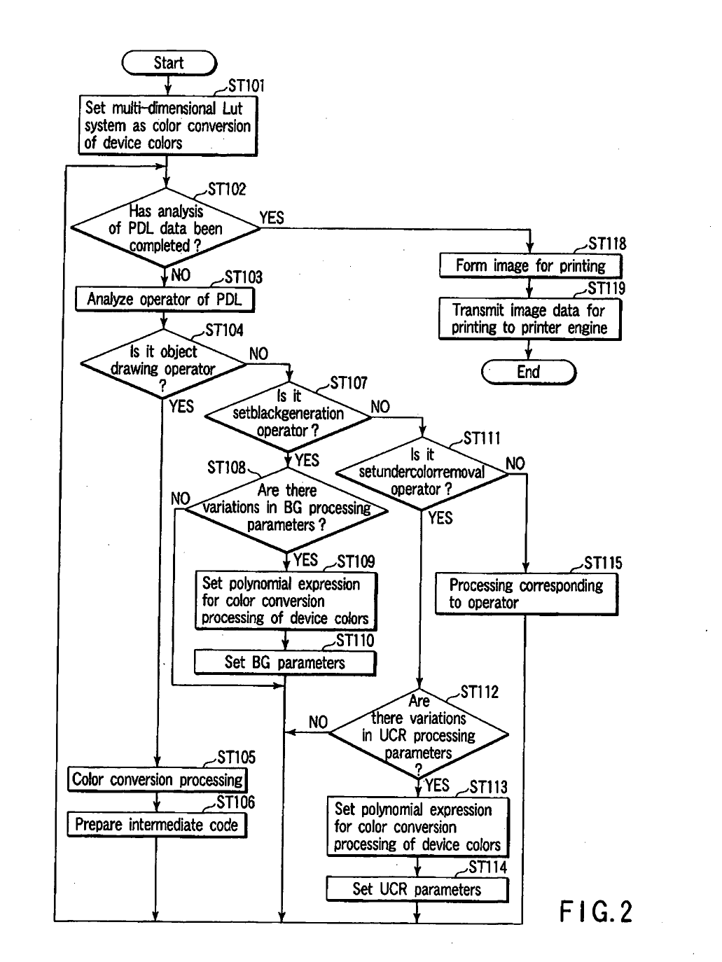

Image formation processing which the CPU 11 executes when the above-described image formation program is executed will be described with reference to FIG. 2. FIG. 2 is a flowchart showing the processing when the CPU 11 executes the image formation program. In the color conversion processing in the image formation processing, one method of both methods of a polynomial color conversion and a multi-dimensional Lut color conversion conforming to a use of PostScript language can be selectively used as a color conversion of device colors.

In the processing flow of the image formation processing, first, the CPU 11 sets a multi-dimensional lookup table (Lut) as a color conversion of device colors (ST101). Next, the CPU 11 determines whether or not the analysis of all the PDL data has been completed (ST102). When it is determined that the analysis of the PDL data has not been completed (No in ST102), the CPU 11 analyzes a described operator by processing the PDL data (ST103). Then, the CPU 11 determines whether or not the analyzed operator is an operator which instructs to draw texts, graphics, images, and the like (ST104). When the analyzed operator is a drawing operator, and in a case of device colors, the CPU 11 carries out color conversion processing by using a multi-dimensional Lut which has been set, and decides colors (ST105). Then, the CPU 11 generates an intermediate code (ST106).

On the other hand, when CPU 11 determines that the operator is not a drawing operator (NO in ST104), the CPU 11 determines whether or not the analyzed operator is a setblackgeneration operator (ST107).

When the CPU 11 determines that the analyzed operator is a setblackgeneration operator (YES in ST107), the CPU 11 determines whether or not the parameters of BlackGeneration (BG) processing which have been set by the operator vary (ST108). When the CPU 11 has determined that the parameters of BG processing vary (YES in ST108), the CPU 11 sets a polynomial color conversion as color conversion processing of device colors (ST109). Then, the CPU 11 sets parameters designated by the operator as the parameters of BG processing (ST110). When the CPU 11 has set the parameters of BG processing (ST110), or when the CPU 11 has determines that the parameters of BG processing do not vary (NO in ST108), the CPU 11 returns to the processing in step ST102, and determines whether or not the analysis of the PDL data has been completed.

Further, when the CPU 11 determines that the analyzed operator is not a setblackgeneration operator (NO in ST107), the CPU 11 determines whether or not the analyzed operator is a setundercolorremoval operator (ST111). When the CPU 11 determines that the analyzed operator is a setundercolorremoval operator (YES in ST111), the CPU 11 determines whether or not the parameters of UnderColorRemoval (UCR) processing vary on the basis of an instruction of the operator (ST112). When the CPU 11 has determined that the parameters of UCR processing vary (YES in ST112), the CPU 11 sets a polynomial color conversion as color conversion processing of device colors (ST113). Then, the CPU 11 sets parameters designated by the operator as the parameters of UCR processing (ST114). When the CPU 11 has set the parameters of UCR processing (ST113), or when the CPU 11 has determines that the parameters of UCR processing do not vary (NO in ST112), the CPU 11 returns to the processing in step ST102, and determines whether or not the analysis of the PDL data has been completed.

On the other hand, when the CPU 11 has determined the analyzed operator is not a setundercolorremoval operator (NO in ST112), the CPU 11 carries out processing in accordance with an instruction of the analyzed operator.

The CPU 11 repeats the processing from step ST102 to step ST115 as described above until all the data are analyzed. When the CPU 11 determines that the analysis of the PDL data has been completed (YES in ST102), the CPU 11 processes to form an image for printing by utilizing the intermediate code prepared in the analysis processing (ST116). Then, the CPU 11 outputs the image data for printing which has been formed to the printer engine 20 (ST117).

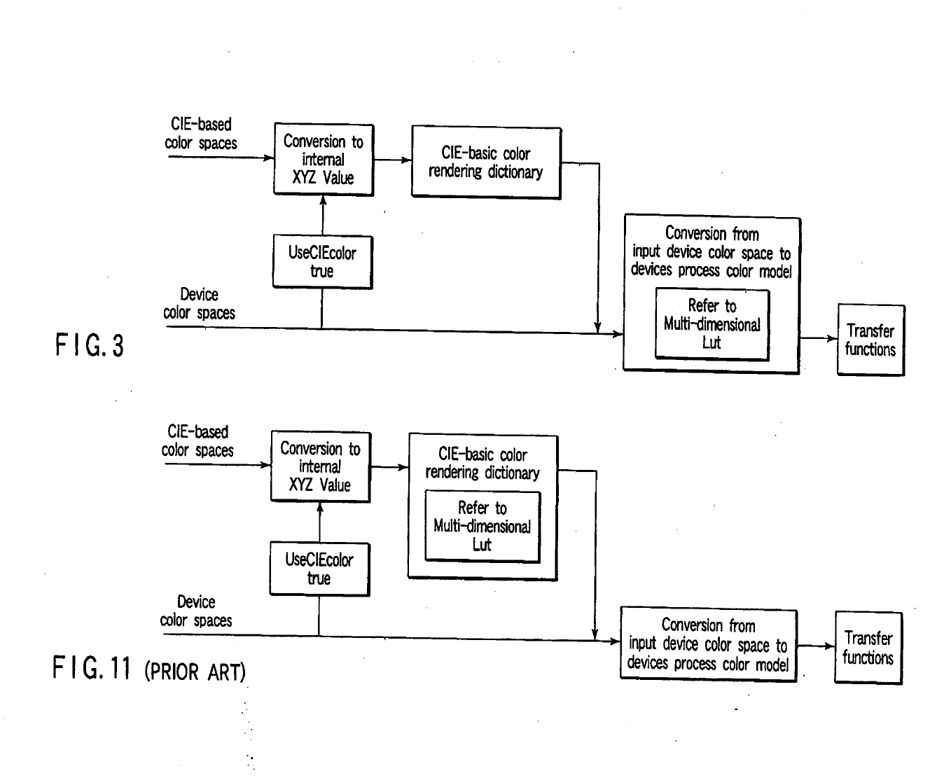

In accordance with the first embodiment, when the printer 1 executes printing of the PDL data in a PostScript format received from the PC 3, color conversion processing of device colors can be carried out by using a multi-dimensional Lut. Specifically, as shown in FIG. 3, as color conversion processing of device colors, the color conversion processing is not carried out with reference to a multi-dimensional Lut after the device colors are converted into the color values of an XYZ color space, but the color conversion processing can be carried out with reference to a multi-dimensional Lut on the basis of the color values of an the device color space. Therefore, an object in device colors can be processed to be printed in colors suitable for the printer 1 at a high speed.

### Second Embodiment

Next, a second embodiment will be described. In the second embodiment, a multi-dimensional Lut of device colors is read in PostScript data format. The configuration of the second embodiment is different from that of the first embodiment in a part of the image formation processing. Namely, in the image formation processing flow, the color conversion processing of device colors itself using a multi-dimensional color conversion Lut is the same as in the first embodiment and the second embodiment. However, the part in which the multi-dimensional color conversion Lut is read in the second embodiment is different from that in the first embodiment. Note that components which are the same as those in the first embodiment described above are denoted by the same reference numerals.

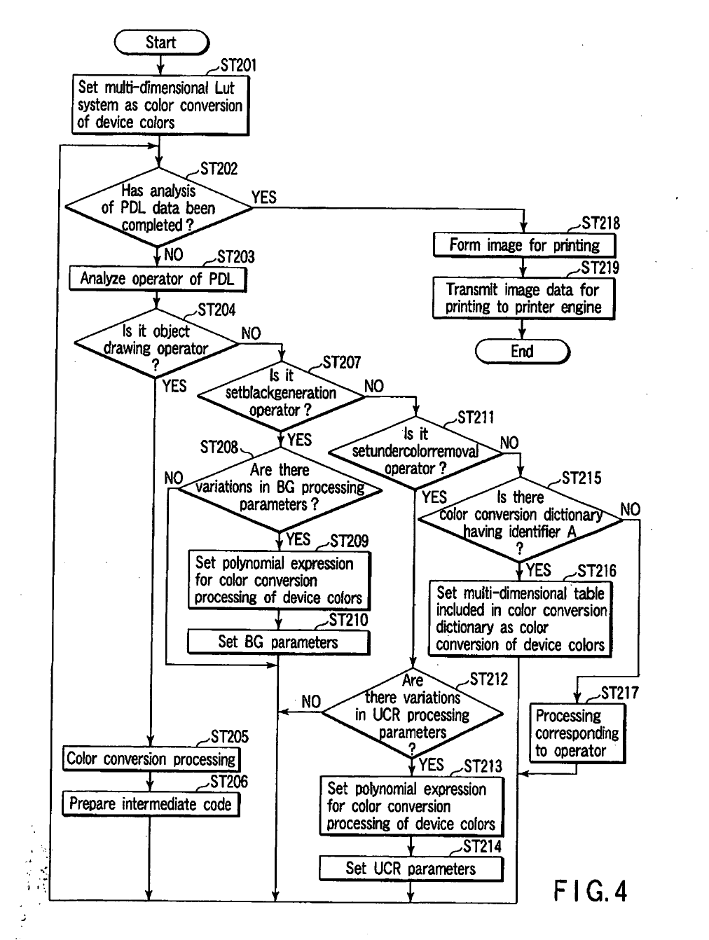

Hereinafter, the second embodiment will be described, focusing on reading of the multi-dimensional color conversion Lut, with reference to FIG. 4. FIG. 4 is a flowchart showing processing when the CPU 11 executes an image formation program in the second embodiment. Note that, because steps ST101 to ST104 described with reference to FIG. 2 are processings which are respectively the same as those in steps ST201 to ST214, and steps ST116 and ST117 are processings which are respectively the same as those in ST218 and ST219, descriptions thereof will be omitted.

When the CPU 11 has determined that the analyzed operator is not an object drawing operator (NO in ST204), is not a setblackgeneration operator (NO in ST207), and is not a setundercolorremoval operator (NO in ST211), the CPU 11 determines whether or not the operator is to define color conversion dictionary data with a specific identifier A (ST215). The identifier A is, for example, ToshibaCRDNo123 in the case of a printer manufactured by Toshiba Corporation.

When the CPU 11 has determined that the operator is an operator with the specific identifier A (YES in ST215), the CPU 11 reads a multi-dimensional table denoted by the identifier A from the color conversion dictionary data, and sets the multi-dimensional table as a multi-dimensional color conversion Lut for use in multi-dimensional color conversion of device colors (ST216). Note that, when the CPU 11 has determined that the operator is not an operator with the specific identifier A (NO in ST215), the CPU 11 carries out processing in accordance with an instruction of the operator (ST217).

When the printer 1 configured in this way receives PDL data including the operator with the specific identifier A which defines color conversion dictionary data, the color conversion dictionary data denoted by the identifier A is read, and the read multi-dimensional color conversion Lut can be utilized for color conversion processing of device colors.

In accordance with the second embodiment, due to the color conversion of device colors, the device colors included in texts can be printed in suitable colors by the printer 1, and moreover, the multi-dimensional color conversion Lut in which colors have been customized can be reflected to image formation.

Further, the PDL relating to the image formation in the second embodiment can be printed by the printer 1 supporting PostScript without bringing about any error.

### Third Embodiment

Next, a third embodiment will be described. In the third embodiment, a multi-dimensional color conversion Lut of device colors is read from the contents of a comment text of PDL data in PostScript format.

The configuration of the third embodiment is different from that of the first embodiment in a part of the image formation processing. Namely, in the image formation processing flow, the color conversion of device colors itself using a multi-dimensional color conversion Lut is the same as in the first embodiment and the third embodiment. However, the part in which the multi-dimensional color conversion Lut is read in the third embodiment is different from that in the first embodiment. Note that components which are the same as those in the first embodiment described above are denoted by the same reference numerals.

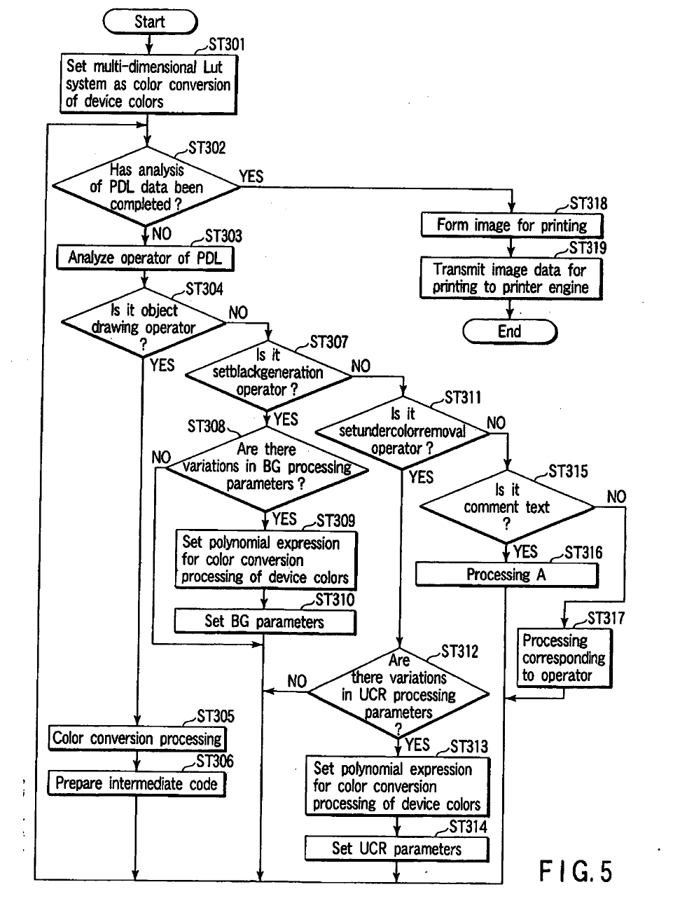

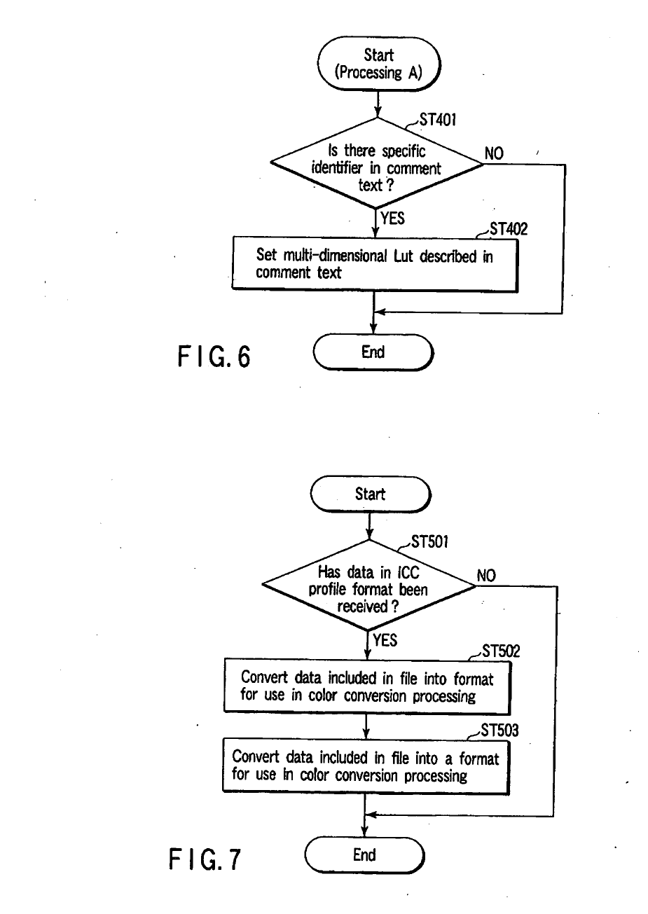

Hereinafter, the third embodiment will be described, focusing on reading of the multi-dimensional color conversion Lut, with reference to FIGS. 5 and 6. FIG. 4 is a flowchart showing processing when the CPU 11 executes an image formation program in the third embodiment. FIG. 5 is a sub-flowchart for explaining processing A in FIG. 4 in detail. Note that, because steps ST101 to ST114 described with reference to FIG. 2 are processings which are respectively the same as those in steps ST301 to ST314, and steps ST116 and ST117 are processings which are respectively the same as those in ST318 and ST319, descriptions thereof will be omitted.

When the CPU 11 has determined that the analyzed PDL data is not an object drawing operator (NO in ST304), is not a setblackgeneration operator (NO in ST307), and is not a setundercolorremoval operator (NO in ST311), the CPU 11 determines whether or not the processing object is a comment text in PostScript (ST315).

When the CPU 11 has determined that the processing object is a comment text (YES in ST315), the CPU 11 determines whether or not there is a specific identifier denoting a multi-dimensional color conversion Lut in the comment text portion (ST401). When the CPU 11 determines that there is the aforementioned specific identifier in the comment text (YES in ST401), the CPU 11 reads the multi-dimensional color conversion Lut described in the comment text, and sets the multi-dimensional color conversion Lut as a multi-dimensional color conversion Lut of device colors (ST402). Further, when the CPU 11 determines that there is no aforementioned specific identifier in the comment text (NO in ST401), the CPU 11 skips over the processing in step ST402. Note that, when the CPU 11 determines that there is no aforementioned specific identifier in the processing object (NO in ST315), the CPU 11 carries out processing in accordance with an instruction of the operator (ST317).

When the printer 1 configured in this way receives PDL data in which the specific identifier denoting a multi-dimensional color conversion Lut has been described in a comment text in PostScript, the multi-dimensional color conversion Lut is read from the comment text, and is set, so that the read multi-dimensional color conversion Lut can be utilized for color conversion processing of device colors.

In accordance with the third embodiment, the multi-dimensional color conversion Lut described in the comment text of PDL data can be reflected to printing, and the device colors can be printed in more suitable colors. Further, the same PDL data can be printed without any error by the normal printer 1 supporting PostScript.

### Fourth Embodiment

Next, a fourth embodiment will be described. In the fourth embodiment, a multi-dimensional color conversion Lut of device colors is read as a file in an ICC profile (a file of color conversion used for all-purpose) format into the printer 1 before printing.

The configuration and the flow of the image formation processing in the fourth embodiment are the same as those in the first embodiment. Therefore, portions which are the same as those in the first embodiment are denoted by the same reference numerals, and descriptions of the flowchart showing the image formation processing and the like will be omitted.

The fourth embodiment is different from the first embodiment in that the multi-dimensional color conversion Lut is downloaded in an ICC profile format in advance of printing. This processing will be described with reference to FIG. 7. FIG. 7 is a flowchart showing processing executed when the CPU 11 receives data in an ICC profile format.

The CPU 11 determines whether or not data in an ICC profile format has been received via the network 2 from the PC 3 (ST501). When the CPU 11 determines that the data in an ICC profile format has been received (YES in ST501), the CPU 11 converts the format of the color conversion table included in the file into a data format which can be read in the multi-dimensional color conversion processing (ST502). Then, the CPU 11 sets the multi-dimensional color conversion Lut whose format has been converted in this way so as to be used for the color conversion of device colors (ST503).

In accordance with the fourth embodiment, a user can reflect the multi-dimensional color conversion Lut of device colors to the printer 1 on the basis of the data received in an ICC profile format. The ICC profile is a file format which is a disclosed specification, and is easily customized by a user.

### Fifth Embodiment

Next, a fifth embodiment will be described. In the fifth embodiment, a color conversion table set by a setcolorrendering operator is reflected to the color conversion processing of device colors.

The configuration of the fifth embodiment is different from that of the first embodiment in a part of the image formation processing. Namely, in the image formation processing flow, the color conversion processing of device colors itself using the multi-dimensional color conversion Lut is the same as in the first embodiment and the fifth embodiment. However, the fifth embodiment is different from the first embodiment in the part in which the multi-dimensional color conversion Lut is read. Note that components which are the same as those in the first embodiment are denoted by the same reference numerals.

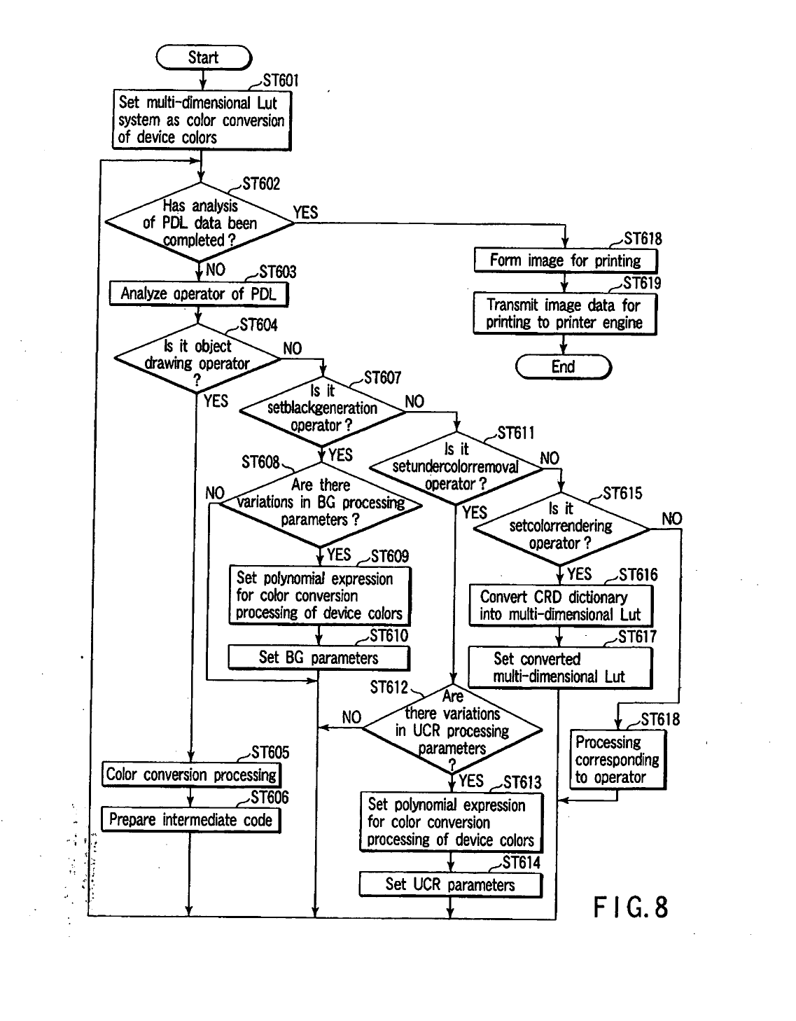

Hereinafter, the fifth embodiment will be described, focusing on reading of the multi-dimensional color conversion Lut, with reference to FIG. 8. FIG. 8 is a flowchart showing processing when the CPU 11 executes an image formation program in the fifth embodiment. Note that, because steps ST101 to ST114 described with reference to FIG. 2 are processings which are respectively the same as those in steps ST601 to ST614, and steps ST116 and ST117 are processings which are respectively the same as those in ST619 and ST620, descriptions thereof will be omitted.

When the CPU 11 has determined that the analyzed PDL data is not an object drawing operator (NO in ST604), and is not a setblackgeneration operator (NO in ST607), and is not a setundercolorremoval operator (NO in ST611), the CPU 11 determines whether or not the analyzed operator is a setcolorrendering operator (ST615).

When the CPU 11 determines that the analyzed operator is a setcolorrendering operator (YES in ST615), the CPU 11 converts the contents of a CRD dictionary into a multi-dimensional color conversion Lut (ST616). Then, the CPU 11 sets the converted multi-dimensional color conversion Lut as the color conversion of device colors, and sets the CRD dictionary as a color space of an XYZ space (ST617). Note that, when the CPU 11 determines that the analyzed operator is not a setcolorrendering operator (NO in ST615), the CPU 11 carries out processing in accordance with an instruction of the operator (ST618).

In the printer 1 configured in this way, the multi-dimensional color conversion Lut table for use in the color conversion of device colors can be set by a setcolorrendering operator.

In accordance with the fifth embodiment, the contents of the color conversion dictionary set by a setcolorrendering operator can be reflected to the color conversion of device colors.

### Sixth Embodiment

Next, a sixth embodiment will be described. In the sixth embodiment, a multi-dimensional color conversion Lut set by a setcolorrendering operator is set as a color conversion table of the multi-dimensional color conversion Lut of device colors at a more high speed.

The configuration of the sixth embodiment is different from that in the first embodiment in a part of the image formation processing. Namely, in the image formation processing flow, the color conversion processing of device colors itself using a multi-dimensional color conversion Lut is the same as in the first embodiment and the sixth embodiment. However, the sixth embodiment is different from the first embodiment in the point that the multi-dimensional color conversion Lut is read. Note that components which are the same as those in the first embodiment are denoted by the same reference numerals.

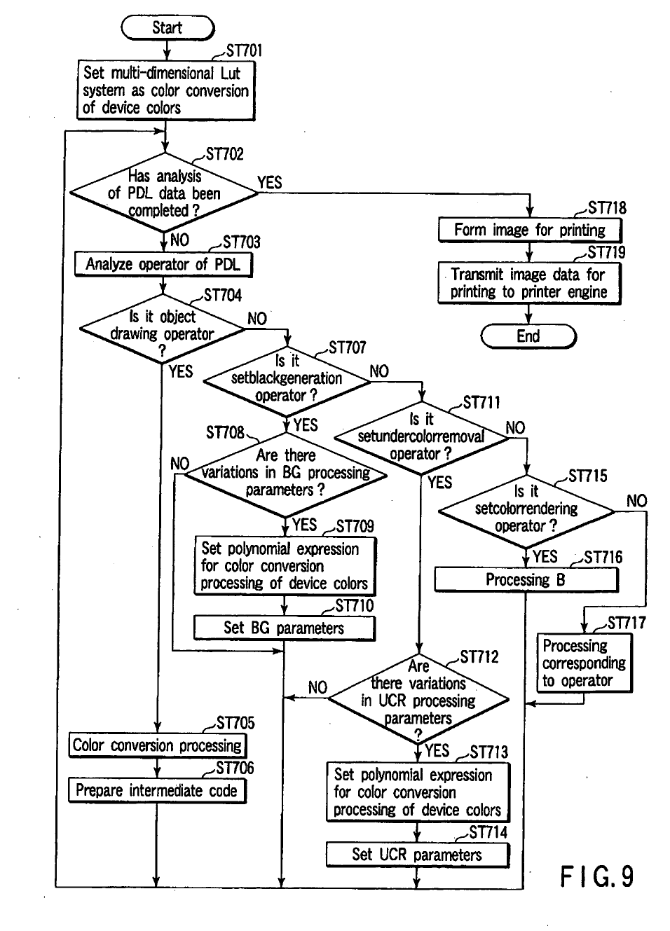

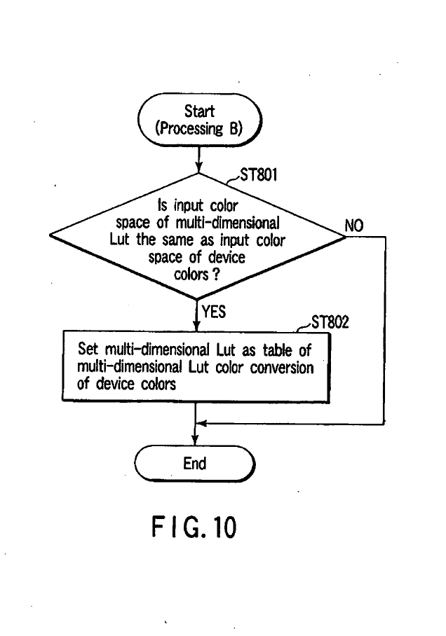

Hereinafter, the sixth embodiment will be described, focusing on reading of the multi-dimensional color conversion Lut, with reference to FIGS. 9 and 10. FIG. 9 is a flowchart showing processing when the CPU 11 executes an image formation program in the sixth embodiment. FIG. 10 is a sub-flowchart for explaining processing B in FIG. 9 in detail. Note that, because steps ST101 to ST114 described with reference to FIG. 2 are processings which are respectively the same as those in steps ST701 to ST714, and steps ST116 and ST117 are processings which are respectively the same as those in ST718 and ST719, descriptions thereof will be omitted.

When the CPU 11 determines that the analyzed PDL data is not an object drawing operator (NO in ST704), is not a setblackgeneration operator (NO in ST707), and is not a setundercolorremoval operator (NO in ST711), the CPU 11 determines whether or not the analyzed operator is a setcolorrendering operator (ST715).

When the CPU 11 determines that the analyzed operator is a setcolorrendering operator (YES in ST715), the CPU 11 determines whether or not an input color space of the multi-dimensional color conversion Lut included in the color conversion dictionary is the same as an input color space of the color conversion of device colors (ST801). When the CPU 11 determines that the input color spaces are the same (YES in ST801), the multi-dimensional color conversion Lut included in the color conversion dictionary is set as a color conversion table of the multi-dimensional color conversion Lut of device colors (ST802). Further, when the CPU 11 determines that the input color spaces are not the same (NO in ST801), the CPU 11 skips over the processing in step ST702. Note that, when the CPU 11 determines that the analyzed operator is not a setcolorrendering operator (NO in ST715), the CPU 11 carries out processing in accordance with an instruction of the operator (ST717).

In the printer 1 configured in this way, only in a case where the input color space of the multi-dimensional color conversion Lut included in the color conversion dictionary is the same as the input color space of the color conversion of device colors when the analyzed operator is a setcolorrendering operator, the multi-dimensional color conversion Lut included in the color conversion dictionary is set as a color conversion table of the multi-dimensional color conversion Lut of device colors.

In accordance with the sixth embodiment, the multi-dimensional color conversion table set by the operator can be set as the color conversion of device colors at high speed.

### Seventh Embodiment

Next, a seventh embodiment will be described. In the seventh embodiment, processing for determining whether or not the input color space of the multi-dimensional color conversion Lut is the same (ST801) in the sixth embodiment described above is carried out at high speed by utilizing an entry in the CRD dictionary.

The configuration of the seventh embodiment is different from that of the sixth embodiment in the processing for determining whether or not the input color space of the multi-dimensional color conversion Lut is the same. Therefore, portions which are the same as those in the sixth embodiment described above are denoted by the same reference numerals, and descriptions of a flowchart showing the image formation processing or the like will be omitted.

Hereinafter, the processing for determining whether or not the input color space of the multi-dimensional color conversion Lut is the same in the seventh embodiment will be described.

In the seventh embodiment, an identifier for distinguishing an input color space of the multi-dimensional Lut is described in advance in the CRD dictionary. The identifier is, for example, sRGB, Lab, XYZ, or the like. Then, the CPU 11 receives PDL data in which descriptions including such an identifier have been carried out via the network 2. Then, the CPU 11 searches for whether or not there is an identifier corresponding to the described identifier in the CRD dictionary on the basis of the received PDL data at the time of analyzing a setcolorrendering operator. Then, the CPU 11 determines whether the input color space of the multi-dimensional color conversion Lut included in the color conversion dictionary is the same as the input color space of the color conversion of device colors in accordance with the result of searching for whether or not there is a corresponding identifier. Namely, when there is an identifier corresponding to the described identifier in the CRD dictionary at the time of analyzing a setcolorrendering operator, the CPU 11 sets it as a color conversion processing table of the multi-dimensional color conversion Lut of device colors. On the other hand, when there is no identifier corresponding to the described identifier in the CRD dictionary at the time of analyzing a setcolorrendering operator, the CPU 11 does not set as a multi-dimensional color conversion Lut of device colors.

In accordance with the seventh embodiment, the printer 1 can carry out the processing for determining whether or not there is setting of the multi-dimensional color conversion Lut at high speed by utilizing an entry in the CRD dictionary.

In accordance with the embodiments described above, in the printer 1 which can print PostScript data, colors of an object described in device colors can be more flexibly customized, and can be printed in optimum colors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image forming apparatus for printing print data described in a page description language in a specific format, the image forming apparatus comprising:
a multi-dimensional Lut color conversion processing unit configured to carry out color conversion processing of a device color space by using a multi-dimensional lookup table.

2. An image forming apparatus for printing print data described in a page description language in PostScript format, the image forming apparatus comprising:
a multi-dimensional Lut color conversion processing unit configured to carry out color conversion processing of a device color space by using a multi-dimensional lookup table.

3. The image forming apparatus according to claim 2, further comprising:
a polynomial color conversion processing unit configured to carry out color conversion processing of a device color space by using a polynomial expression; and
a switching unit configured to switch the multi-dimensional Lut color conversion processing unit and the polynomial color conversion processing unit at the time of carrying out color conversion processing.

4. The image forming apparatus according to claim 2, further comprising an input unit to input the multi-dimensional lookup table from the exterior.

5. The image forming apparatus according to claim 4, further comprising:
a CRD data reception unit configured to receive data showing the multi-dimensional lookup table as CRD data which is described so as to have a specific identifier in a color rendering dictionary format conforming to the PostScript language specification via the input unit; and
a setting unit configured to, with respect to processing for analyzing a page description language, set the received CRD data with a specific identifier as a multi-dimensional lookup table for use in the multi-dimensional Lut color conversion processing unit.

6. The image forming apparatus according to claim 4, further comprising:
an ICC data reception unit configured to receive data showing the multi-dimensional lookup table as data in an ICC profile format via the input unit;
a conversion unit configured to convert the received data in an ICC profile format into a format which is settable in the multi-dimensional Lut color conversion processing unit; and
a setting unit configured to set the data showing the multi-dimensional lookup table, whose format has been converted by the conversion unit, as a multi-dimensional lookup table for use in the multi-dimensional Lut color conversion processing unit.

7. The image forming apparatus according to claim 4, further comprising:
a data reception unit configured to receive data showing the multi-dimensional lookup table as data which is described so as to have a specific identifier in a comment text of the print data via the input unit; and
a setting unit configured to, with respect to processing for analyzing a page description language, when the specific identifier is provided in the comment text, set the multi-dimensional lookup table described in the comment text as a multi-dimensional lookup table for use in the multi-dimensional Lut color conversion processing unit.

8. The image forming apparatus according to claim 4, further comprising:
a reception unit configured to receive print data including a description for setting CRD data conforming to a PostScript language specification by a setcolorrendering operator; and
a setting unit configured to, with respect to processing for analyzing a page description language, convert a multi-dimensional table in the CRD data set by the setcolorrendering operator into a table of an input color space which is available in the multi-dimensional Lut color conversion processing unit, and to set it as a multi-dimensional lookup table for use in the multi-dimensional Lut color conversion processing unit.

9. The image forming apparatus according to claim 4, further comprising:
a reception unit configured to receive print data including a description for setting CRD data conforming to the Postscript language specification by a setcolorrendering operator;
a determining unit configured to, with respect to processing for analyzing a page description language, determine whether or not an input color space of a multi-dimensional table in the CRD data set by the setcolorrendering operator is the same as an input color space which is available in the multi-dimensional Lut color conversion processing unit; and
a setting unit configured to, when the determining unit determines that the input spaces are the same, set the multi-dimensional table in the CRD data as a color conversion table of the multi-dimensional Lut color conversion processing unit.

10. A method of carrying out color conversion processing of an image forming apparatus which prints print data described in a page description language in a Postscript format, the method comprising:
carrying out color conversion processing of a device color space by using a multi-dimensional lookup table.

11. The method according to claim 10, comprising
when color conversion processing of a device color space is carried out, switching color conversion processing which is carried out by using a polynomial expression and color conversion processing which is carried out by using the multi-dimensional lookup table, wherein
the color conversion processing of a device color space is carried out in accordance with the switched color conversion processing.

12. The method according to claim 10, further comprising
inputting the multi-dimensional lookup table from the external.

13. The method according to claim 10, further comprising:
receiving data showing the multi-dimensional lookup table as CRD data which is described so as to have a specific identifier in a color rendering dictionary format conforming to the PostScript language specification; and
with respect to processing for analyzing a page description language, setting the received CRD data with a specific identifier as a multi-dimensional lookup table for use in the color conversion processing.

14. The method according to claim 10, further comprising:
receiving data showing the multi-dimensional lookup table as data in an ICC profile format;
converting the received data in an ICC profile format into a format for use in the color conversion processing; and
setting the multi-dimensional lookup table whose format has been converted as a multi-dimensional lookup table for use in the color conversion processing.

15. The method according to claim 10, further comprising:
receiving data showing the multi-dimensional lookup table as data which is described so as to have a specific identifier in a comment text of the print data; and
with respect to processing for analyzing a page description language, when the specific identifier is provided in the comment text, setting the multi-dimensional lookup table described in the comment text as a multi-dimensional lookup table for use in the color conversion processing.

16. The method according to claim 10, further comprising:
receiving print data including a description for setting CRD data conforming to the PostScript language specification by a setcolorrendering operator;
with respect to processing for analyzing a page description language, converting a multi-dimensional table in the CRD data set by the setcolorrendering operator into a table of an input color space which is available in the color conversion processing; and
setting the converted table as a multi-dimensional lookup table for use in the color conversion processing.

17. The method according to claim 10, further comprising:
receiving PDL data including a description for setting CRD data conforming to the PostScript language specification by a setcolorrendering operator;
with respect to processing for analyzing a page description language, determining whether or not an input color space of the multi-dimensional table in the CRD data set by the setcolorrendering operator is the same as an input color space which is available in the color conversion processing; and
when it is determined that the input spaces are the same, setting the multi-dimensional table in the CRD data as a color conversion table of the color conversion processing.
